(19) United States
(12) Patent Application Publication
(10) Pub. No.: US 2024/0151550 A1
(43) Pub. Date: May 9, 2024

(54) METHOD AND DEVICE WITH TRAFFIC LIGHT STATE DETERMINATION

(71) Applicant: SAMSUNG ELECTRONICS CO., LTD., Suwon-si (KR)

(72) Inventors: Jahoo KOO, Suwon-si (KR); Jaemuk JEONG, Suwon-si (KR); Seho SHIN, Suwon-si (KR); Dae Hyun JI, Suwon-si (KR)

(73) Assignee: SAMSUNG ELECTRONICS CO., LTD., Suwon-si (KR)

(21) Appl. No.: 18/349,393

(22) Filed: Jul. 10, 2023

(30) Foreign Application Priority Data
Nov. 7, 2022 (KR) 10-2022-0147403

(51) Int. Cl. G01C 21/00; B60W 60/00; G06T 7/70; G06V 20/58

(52) U.S. Cl. CPC G01C 21/3811; B60W 60/001; G01C 21/3848; G06T 7/70; G06V 20/584; B60W 2420/42; B60W 2555/60; B60W 2556/40; G06T 2207/30252

(57) ABSTRACT

A method of determining a signal state of a target traffic light includes: acquiring an isolated image of the target traffic light from an input image of the target traffic light, wherein the input image is captured when the vehicle is at a position, wherein the isolated image is acquired using image processing on the input image, the input image having been captured by a camera module of the vehicle; acquiring information about the target traffic light based on a map position in map data, the map position corresponding to the position of the vehicle when the input image is acquired; and determining the signal state of the target traffic light based on the isolated image of the target traffic light and based on the information about the target traffic light.

### CROSS-REFERENCE TO RELATED APPLICATIONS

This application claims the benefit under 35 USC § 119(a) of Korean Patent Application No. 10-2022-0147403, filed on Nov. 7, 2022, in the Korean Intellectual Property Office, the entire disclosure of which is incorporated herein by reference for all purposes.

### BACKGROUND

### 1. Field

The following description relates to techniques for determining a signal state of a traffic light.

### 2. Description of Related Art

An autonomous driving system may automatically drive a vehicle to a given destination by recognizing a road environment, determining a driving situation, and controlling the vehicle according to a planned driving route. An autonomous vehicle may use deep learning technology to identify roads, vehicles, people, motorcycles, road signs, traffic lights, and the like, and may use this identified information as data for controlling autonomous driving. In autonomous driving, failure in identifying an object, an item, or a person that needs to be identified may lead to an accident. Accordingly, the reliability in identifying roads, vehicles, people, motorcycles, road signs, and traffic signals may be an essential factor for safe and reliable autonomous driving. In particular, when an autonomous vehicle does not properly determine the signal state of a traffic light, there may be substantial risk of a large-scale disaster. Accordingly, an autonomous vehicle may need high reliability in determining the signal state of a traffic light.

Determination of signal state of a traffic light may have applications other than informing autonomous driving systems. For example, a vehicle may have a warning system to warn a driver of the vehicle of a dangerous situation. A vehicle may have a safety system that overrides manual driving with automatic braking or automatic evasive steering, which may also use traffic light information.

The above description has been possessed or acquired by the inventor(s) in the course of conceiving the present disclosure and is not necessarily an art publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of determining a signal state of a target traffic light includes: acquiring an isolated image of the target traffic light from an input image of the target traffic light, wherein the input image is captured when the vehicle is at a position, wherein the isolated image is acquired using image processing on the input image, the input image having been captured by a camera module of the vehicle; acquiring information about the target traffic light based on a map position in map data, the map position corresponding to the position of the vehicle when the input image is acquired; and determining the signal state of the target traffic light based on the isolated image of the target traffic light and based on the information about the target traffic light.

The acquiring of the isolated image of the target traffic light may include: identifying candidate traffic lights based on determining that the candidate traffic lights are in front of the vehicle along a driving route of the vehicle; and selecting, as the target traffic light, whichever of the candidate traffic lights is determined to be closest to the vehicle.

The acquiring of the information about the target traffic light may includes: detecting the position of the vehicle using a position sensor; determining a vehicle-map-point corresponding to the detected position of the vehicle, wherein the vehicle-map-point is in a map included in the map data; selecting, based on the vehicle-map-point, a virtual traffic light among virtual traffic lights in the map as a target virtual traffic light that corresponds to the target traffic light; and acquiring the information about the target traffic light based on the selection of the target virtual traffic light.

The information about the target traffic light may include first information indicating a number of lamps of the target traffic light and second information indicating signal-types of respective positions of the lamps of the target traffic light.

The determining of the signal state of the target traffic light may include determining the sequential position of an illuminated lamp of the target traffic light based on the isolated image of the target traffic light.

The calculating the sequential position may include dividing the isolated image into areas respectively corresponding to the lamps of the target traffic light and computing average intensity values of the respective areas.

The illuminated lamp may be selected as a basis for determining the signal state, and the illuminated lamp may be selected based on the average intensity value of its corresponding area.

The sequential position may be determined by inputting the isolated image of the target traffic light to a neural network.

The determining of the signal state of the target traffic light may include extracting the signal information from among a set of signal information based on the signal information corresponding to the determined sequential position.

In another general aspect, an electronic device for determining a signal state of a target traffic light includes: a camera module configured to capture an image of the surroundings of a vehicle connected with the electronic device; one or more processors; memory storing instructions configured to cause the one or more processors to: receive map data from a server; acquire an isolated image of the target traffic light from an input image of the target traffic light captured by the camera module while the vehicle is at a sensed physical location; acquire, from the map data, information about the target traffic light, using the sensed physical location of the vehicle; and determine the signal state of the target traffic light based on the isolated image of the target traffic light and the information about the target traffic light.

The instructions may be further configured to cause the one or more processors to: identify candidate traffic lights from images captured by respective cameras of the camera module, wherein the candidate traffic lights are determined based on being in front of the vehicle according to a driving route of the vehicle, and select, as the target traffic light, whichever candidate traffic light is determined to be closest to the vehicle among the identified candidate traffic lights.

The instructions may be further configured to cause the one or more the processors to: determine a vehicle-map-point corresponding to the sensed physical location of the vehicle in the map data; select a virtual traffic light related to the determined vehicle-map-point among a plurality of virtual traffic lights in the map data as a target virtual traffic that corresponds to the target traffic light; and acquire the information about the target traffic light based on the selected target virtual traffic light.

The information about the target traffic light may include traffic-signal types respectively associated with sequential positions of lamps of the target traffic light.

The instructions may be further configured to cause the one or more processors to determine, from the isolated image of the target traffic light, a sequential position of a turned-on lamp of the target traffic light, and determine the signal state of the target traffic light to be the traffic-signal type associated with the determined sequential position of the turned-on lamp.

The instructions may be further configured to cause the one or more processors to compute pixel-intensity measures of areas in the isolated image that contain respective lamps of the target traffic light.

The instructions may be further configured to cause the one or more processors to determine the sequential position of the turned-on lamp based on the pixel-intensities.

The instructions may be further configured to cause the one or more processors to determine the sequential position by inputting the isolated image of the target traffic light to a neural network, wherein the neural network performs an inference on the isolated image to generate the sequential position.

The determined sequential position may be used to select the traffic-signal type from among the signal-types associated with the target traffic lamp.

In another general aspect, a method includes: sensing a location of a moving vehicle when a camera of the vehicle captures an image of a target traffic light; mapping the sensed location of the vehicle to a vehicle-map-location in a map, wherein the map includes traffic light elements at respective map locations in the map, wherein each traffic light element has a respectively associated signal record, wherein each signal record indicates traffic-signal-types of respective lamp positions of the corresponding traffic light element; determining a route of the moving vehicle in the map according to the vehicle-map-location; selecting candidate traffic light elements from among the traffic light elements based on the route in the map, and selecting, from among the candidate traffic light elements, a target traffic light element as representative of the target traffic light; determining, based on the image of the target traffic light, a sequential lamp position of a turned-on lamp of the target traffic light; and determining a current traffic signal state of the target traffic light to be the traffic-signal-type in the signal record of the target traffic light element whose lamp position matches the determined sequential lamp position.

The determined current traffic signal state may be used to control an autonomous or assisted driving system that is at least partially controlling driving of the vehicle.

Other features and aspects will be apparent from the following detailed description, the drawings, and the claims.

### BRIEF DESCRIPTION OF THE DRAWINGS

FIG. 1 illustrates an example process in which an electronic device determines a signal state of a target traffic light, according to one or more embodiments.

FIG. 2 illustrates an example electronic device, according to one or more embodiments.

FIG. 3 illustrates an example process in which an electronic device determines a signal state of a target traffic light, according to one or more embodiments.

FIGS. 4A and 4B illustrate examples of an electronic device using image processing to determine a lamp sequence stage in a target traffic light, according to one or more embodiments.

FIG. 5 illustrates an example process in which an electronic device uses a neural network to identify an illuminated lamp of a target traffic light, according to one or more embodiments.

FIG. 6 illustrates an example process of an electronic device using sequence stages of lamp illuminations of a target traffic light to determine the signal state of the target traffic light, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

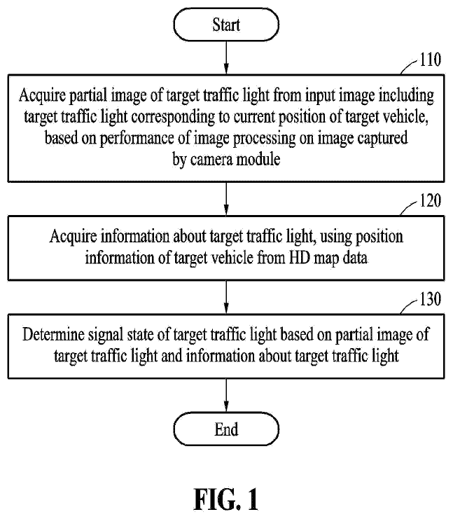

FIG. 1 illustrates an example process in which an electronic device determines a signal state of a target traffic light.

A traffic light may be installed at an intersection or a crosswalk on the road and may be a device instructing vehicles in operation or pedestrians to stop, detour, or proceed by turning on or off red, green, and yellow lights and a green arrow sign. An autonomous driving system may need to accurately determine the signal state of a traffic light. Hereinafter, the operation of an electronic device to determine the signal state of a traffic light is described in detail.

In operation 110, the electronic device according to an example may acquire an isolated image of a target traffic light from an input image including the target traffic light (the input image corresponding to the current position of a vehicle) based on image processing on an input image captured by a camera module. The isolated image of the target traffic light may be an image in which image data of the target traffic light has been isolated (e.g., containing mostly image data of the target traffic light).

The electronic device may be connect with (or part of) the vehicle. A controller of the electronic device may connect to the vehicle to control the driving of the vehicle. The electronic device may determine a signal state of the target traffic light corresponding to the current position of the vehicle and may control operation of the vehicle according to the determined signal state of the target traffic light. The target traffic light may be identified as a traffic light closest to the vehicle among traffic lights in front of the vehicle on a driving route of the vehicle. For example, when the electronic device determines that the signal state of the target traffic light is ‘stop’, the electronic device may gradually reduce the driving speed of the vehicle. For example, when the electronic device determines that the signal state of the target traffic light is a ‘driving straight’ state, the electronic device may maintain the driving speed of the vehicle at a current speed.

The electronic device may extract an input image including the target traffic light from an image captured by a camera module. For example, the electronic device may extract, as an input image, an image frame including the target traffic light among a plurality of image frames captured by the camera module. The electronic device may obtain an isolated image of the target traffic light by cropping an area corresponding to the target traffic light in the extracted input image.

In operation 120, the electronic device may acquire information about the target traffic light using position information of the vehicle from high definition (HD) map data. The HD map data may include, for example, a high-precision map implemented as a 3D model and information about lanes, such as boundary lines, road surfaces, signs, curbs, traffic lights, and various structures/elements/objects. The electronic device may use the position information of the vehicle to search for a target virtual traffic light mapped to (corresponding to) the target traffic light among a plurality of virtual traffic lights in the HD map.

According to an example, a communicator of the electronic device may receive the HD map data from a server. The communicator of the electronic device may update information about an existing HD map by periodically receiving the HD map data from the server. According to another example, the electronic device may store the HD map data in a memory in advance and perform the following operation without receiving the HD map data from the server. The electronic device may acquire information about the target traffic light by extracting information about a target virtual traffic light mapped to the target traffic light from the HD map data. That is, the electronic device may determine information about the target virtual traffic light mapped to the target traffic light to be the information about the target traffic light.

In operation 130, the electronic device may determine a signal state of the target traffic light based on the isolated image of the target traffic light and the information about the target traffic light. The signal state of the target traffic light may include, for example, a ‘stop’ state, a ‘driving straight’ state, and a ‘driving straight and turning left’ state but is not limited thereto. The electronic device may identify one or more turned-on lamps among a plurality of lamps included in the target traffic light and calculate sequential position(s) of the one or more turned-on lamps. The electronic device may extract signal information mapped to the sequential position of a turned-on lamp from the information about the target traffic light and combine the extracted signal information to determine a signal state of the target traffic light.

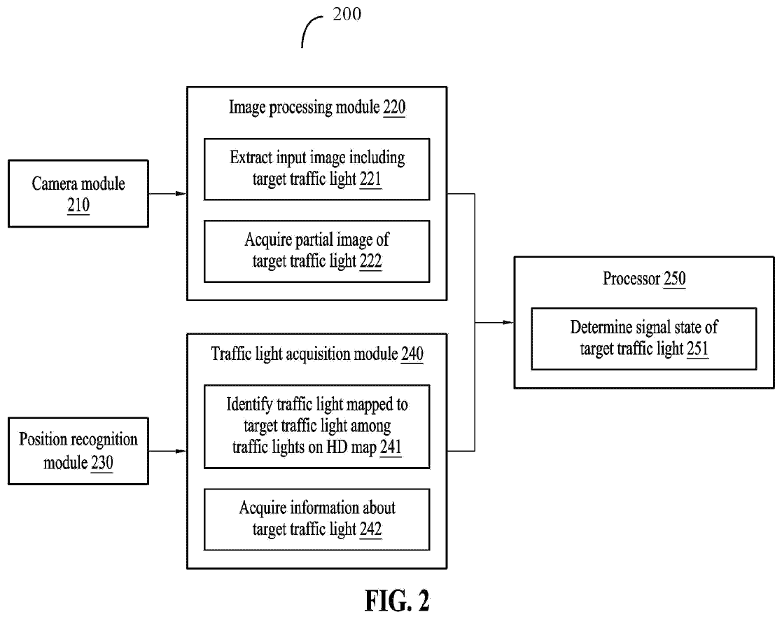

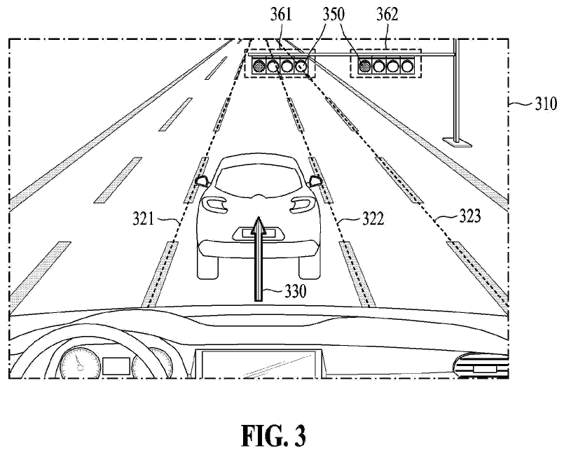

FIG. 2 illustrates an example electronic device 200. FIG. 3 illustrates an example process in which an electronic device (e.g., the electronic device 200) determines a signal state of a target traffic light. The electronic device 200 may be included in a vehicle. Referring to FIG. 2, the electronic device 200 may include a camera module 210 configured to photograph the outside of the vehicle and an image processing module 220 configured to perform image processing on images captured by the camera module 210. For example, the camera module 210 may include multiple cameras and/or sensors that may photograph the outside of the vehicle in various directions from various positions of the individual cameras (embodiments may be implemented with only a single camera/sensor). The positions and directions of the individual cameras may be known in advance and used for the image processing. The camera module 210 may capture an image of a traffic light near the vehicle. Images captured by the camera module 210, e.g., an image of a traffic light, may be provided to the image processing module 220.

The image processing module 220 may perform image processing on the traffic light input image received from the camera module 210. Specifically, the image processing module 220 may extract (or delineate) an isolated image of a target traffic light (e.g., a “mostly traffic light” image cropped from the input image or delineated within the input image) from the input of the target traffic light, where the isolated image corresponds to the current position of the vehicle. Here, “current position” does not refer to the literal current physical position of the vehicle when the isolated traffic light image is extracted, but rather refers to the position of the vehicle when the input image was captured by the camera module 210; in a real-time processing implementation, the time of capture and processing may be close enough to refer to the capture position as the “current position”.

More specifically, in operation 221, the image processing module 220 may obtain the input image of the target traffic light from images received from the camera module 210. For example, when the image processing module 220 receives multiple images from the camera module 210 (e.g., images from different cameras captured around the same time), the image processing module 220 may select therefrom images including the target traffic light. The image processing module 220 may receive the images from the camera module 210 along with indications of photographing directions (e.g., a front direction, a rear direction, a left front direction, a left rear direction, and the like) of the respective images, that is, indications of various directions pointing away from the vehicle (which may be directions relative to a frame of reference of the vehicle). The image processing module 220 may select one or more images from among the received images according to the indicated photographing directions thereof, and specifically, may select an input having an associated photographing direction likely to include a target traffic light. For example, since traffic lights are generally in front of a vehicle, the image processing module 220 may select an image whose indicated capturing direction is the front direction of the vehicle. However, the present disclosure is not limited thereto, and the electronic device may extract or select the input image expected to include a traffic light by selecting an image captured in a lateral direction or a rear direction with respect to the vehicle.

According to an example, the image processing module 220 may perform object recognition to detect a traffic light in a direction-selected image. When multiple traffic lights are detected in a direction-selected image (e.g., a front image), the image processing module 220 may determine a target traffic light corresponding to the current position of the vehicle among the identified traffic lights. As part of a process for determining/selecting a target traffic light, a process for selecting an input image from among a set of frames is described next; the set of image frames may be captured at (or nearly at) the same time in different photographing directions (i.e., with different cameras).

According to an example, the image processing module 220 may predict the driving path of the vehicle in an image frame based on lanes (or lane lines) identified in the image frame. The image processing module 220 may identify road traffic lanes for each of the image frames (which include the to-be-selected input image. The image processing module 220 may predict the driving path of the vehicle in the set of image frames by, for example, identifying lane lines within which the vehicle drives.

Referring to FIG. 3, the image processing module 220 may identify lane lines 321, 322, and 323 in an image frame 310 and predict a driving path 330 of a vehicle in the image frame 310 based on the lane lines 321 and 322 within which the vehicle is driving. According to another example, the image processing module 220 may predict a driving path of the vehicle in an image frame using an autonomous driving system mounted on the vehicle. For example, the image processing module 220 (or the autonomous driving system) may predict the driving path of the vehicle in an image frame based on objects detected/recognized in the image frame, which correspond to objects used for navigation information. Any method of predicting a driving path of the vehicle in an image frame may be used.

The target traffic light may be a traffic light that is eventually determined to be closest to the vehicle among traffic lights detected in front of the vehicle on the predicted driving path of the vehicle (here, what is closest may vary, for example, a “closest” traffic light may be one that is closest to the vehicle and also lies in or near the driving path of the vehicle). Therefore, to select the target traffic light, for each of the image frames included in the set of image frames, the image processing module 220 may identify a candidate traffic light closest to the vehicle among traffic lights in front of the vehicle on the driving path. As described above, the image processing module 220 may determine a driving path of the vehicle based on identified lane lines (or identified lanes) or may determine a driving path of the vehicle using the autonomous driving system, for example.

Further referring to FIG. 3, the image processing module 220 may identify a candidate traffic light 350 closest to the vehicle among traffic lights determined to be in front of the vehicle on the driving path 330 of the vehicle with respect to the image frame 310. According to an example, the image processing module 220 may select one of the detected candidate traffic lights as the target traffic light by comparing the detected candidate traffic lights detected in each of the image frames to each other. For example, an image frame whose camera's field of view does not include the target traffic light, traffic lights other than the target traffic light may be detected as candidate traffic lights in front of the vehicle on the driving path. That is, since candidate traffic lights identified in image frames may or may not be the target traffic light being sought, candidate traffic lights identified in each of the image frames (e.g., frames of different photographing directions) may need to be compared to each other to determine which of the candidate traffic lights is the target traffic light (i.e., which satisfies a condition such as being closest on the driving path). The image processing module 220 may determine, through image processing, which of the candidate traffic lights is actually closest to the vehicle among the candidate traffic lights detected in each of the image frames included in the set of image frames. The image processing module 220 may select, as the target traffic light, the candidate traffic light determined to be closest to the vehicle. For example, when candidate traffic lights are identified in the set of image frames, the image processing module 220 may use an object around the candidate traffic lights (e.g., an object near and common to the candidate traffic lights) to determine which candidate traffic light is closest to the vehicle. The image processing module 220 may select, as an input image for traffic light processing (described next), the image frame that includes the selected candidate traffic light. One or more images may be selected as input images, however, for discussion, processing of one selected input image is described next.

In operation 222, the image processing module 220 may acquire an isolated image of the target traffic light by extracting (or delineating) an area corresponding to the target traffic light from the selected input image. The image processing module 220 may obtain or generate a bounding box that surrounds the target traffic light from the input image including the target traffic light and may copy (or use) only an area of the input image corresponding to the generated bounding box to acquire the isolated image of the target traffic light (the bounding box may be provided by object detection/recognition preformed earlier). For example, referring to FIG. 3, when the image processing module 220 determines/selects candidate traffic light 350 in the image frame 310 to be the target traffic light, the image processing module 220 may generate bounding boxes 361 and 362 that surround the target traffic light 250 in the input image. As shown in FIG. 3, the image processing module 220 may generate the bounding boxes to entirely surround the target traffic light 250 but is not limited thereto. The image processing module 220 may generate a bounding box to surround only lamps included in the target traffic light 250. The image processing module 220 may copy areas of the bounding boxes 361 and 362 generated in the image frame 310 to acquire the isolated images of the target traffic light.

According to an example, the electronic device may include a position recognition module 230 configured to detect position information of the vehicle and a traffic light information acquisition module 240 configured to extract information about a target traffic light from the HD map data mentioned above.

The position recognition module 230 may detect the position information of the vehicle, using any known techniques, for example, using a position sensor (e.g., a global positioning system (GPS) sensor). The position recognition module 230 may transmit the position information of the detected vehicle to the traffic light information acquisition module 240. The traffic light information acquisition module 240 may include a communicator that receives the HD map data and the position information of the vehicle from a server. The traffic light information acquisition module 240 may extract information about the target traffic light from the HD map data based on the position information of the vehicle received from the position recognition module 230. The HD map may be a two or three dimensional model of surroundings of the vehicle, e.g., a point cloud, a vector map, a polygon model, an image or feature map, etc. The HD map may be generated by electronics of the vehicle and/or obtained from an outside source. The HD map may include indications of objects such as traffic lights at respective locations in the HD map, which will be referred to herein as virtual traffic lights (e.g., modeled/mapped traffic lights). Such objects may have respectively corresponding records containing data about the objects. For example, some of the objects may represent traffic lights (traffic light elements) and the corresponding records may contain information about the traffic lights, e.g., for a given traffic light object, its record may indicate which signal-types are associated with which lamp positions of the given traffic light object.

In operation 241, the traffic light information acquisition module 240 may identify a virtual traffic light mapped to (corresponding to) the target traffic light among a plurality of virtual traffic lights on the HD map included in the HD map data.

More specifically, the traffic light information acquisition module 240 may determine a vehicle-map-point which is a point in the HD map corresponding to the current position of the vehicle, for example by using a coordinate-system transform. The traffic light information acquisition module 240 may identify, as the virtual traffic light mapped to (corresponding to) the target traffic light, one of the virtual traffic lights (in the HD map) that is related to the determined vehicle-map-point among the plurality of virtual traffic lights on the HD map. For example, such a target virtual traffic light may be obtained by determining a map route of the vehicle in the HD map and, finding whichever virtual traffic light is closest to the map route and in front of the vehicle-map-point.

In operation 242, the traffic light information acquisition module 240 may acquire information about the target traffic light by extracting information about the target (selected) virtual traffic light. The information about the traffic light may include first information, which is information indicating the number of lamps included in the traffic light and second information, which may indicate an illumination sequence of the lamps by lamp position, as well as traffic functions of the lamps. For example, the first information may indicate that the traffic light includes 4 lamps. Continuing the example, the second information may be a sequence that includes four stages. The first stage is mapped to signal information of ‘stop’ and is associated with the first of the lamps (e.g., a leftmost lamp). The second stage of the sequence is mapped to signal information of ‘caution’ and is associated with the second of the lamps (e.g., second from left). The third stage of the sequence is mapped to signal information of ‘left turn’ and is associated with the third of the lamps (e.g., third from left). The fourth stage of the sequence is mapped to signal information of ‘driving straight’ and is associated with the fourth lamp (e.g., rightmost). Put another way, the second information of a virtual traffic light may be traffic-signal-types of respective sequential positions of the lamps of the virtual traffic light.

In operation 251, a processor 250 may determine a signal state of the target traffic light based on the isolated image of the target traffic light acquired by the image processing module 220 and based on the information about the target traffic light acquired by the traffic light information acquisition module 240. The processor 250 may use the isolated image of the target traffic light acquired by the image processing module 220 to calculate a current sequence stage of the target traffic light according to the relative position of whichever lamp of the target traffic light is identified as being turned on in the isolated image (image processing may be used to determine which lamp in the isolated image has features indicating “illuminated”). The processor 250 may determine the signal state of the target traffic light by extracting/accessing the signal information of the sequence stage that corresponds to the lamp that is turned on. For example, if the second lamp is determined to be on/illuminated, the signal information of the second stage in the sequence (corresponding to the second lamp) may be accessed/obtained, and such information includes the current signal state of the target traffic light (e.g., ‘caution’ in the example). For reference, the operations of the image processing module 220 (e.g., the operations 221 and 222) and the operations of the traffic light information acquisition module 240 (e.g., operations 241 and 242), described above, may be performed by the processor 250 of the electronic device.

The electronic device according to an example may determine a current sequential stage (or sequence position) of the target traffic light according to the relative position of which lamp is turned (illuminated) in the target traffic light, and the on/illuminated position may be determined using the isolated image of the target traffic light. The electronic device may determine the sequential stage (and related information) according to the relative position of the on/illuminated lamp in the target traffic light through image processing technology or neural network technology.

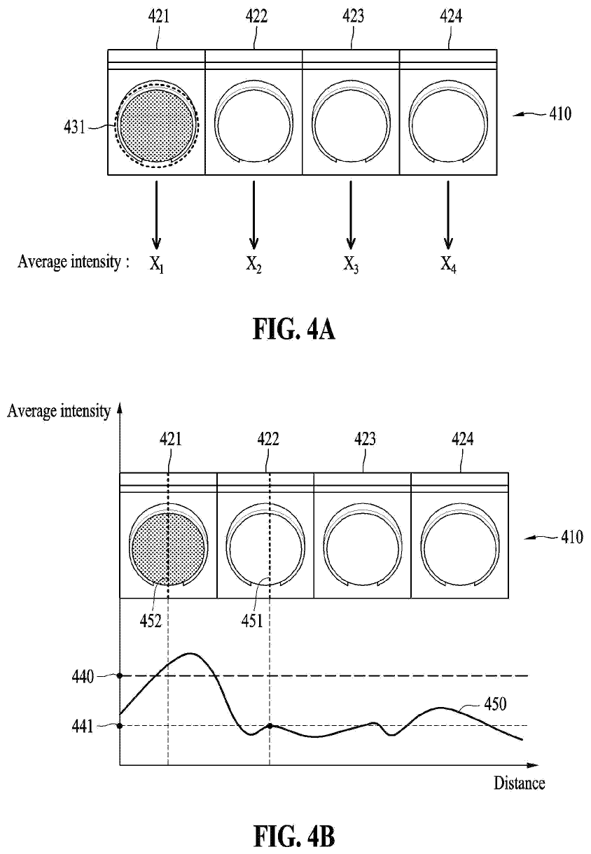

FIGS. 4A and 4B illustrate an example of an electronic device using image processing technology to determine a lamp illumination sequence in a target traffic light, according to one or more embodiments.

The electronic device according to an example may apply the image processing technology to an isolated image 410 of the target traffic light to determine a sequence stage of the target traffic light according to the relative position of a lamp turned on in the target traffic light. The electronic device may determine the sequence stage according to the relative position of the lamp turned on, based on first information about the number of lamps included in the target traffic light acquired from the isolated image 410 of the target traffic light and a traffic light information acquisition module (e.g., the traffic light information acquisition module 240 of FIG. 2).

According to an example, when the electronic device acquires two or more isolated images of the target traffic light, one isolated image may be selected from among the two to determine a sequence stage according to the relative position of a lamp turned on in the target traffic light.

The electronic device may divide the isolated image 410 into areas (e.g., areas 421-424). The electronic device may divide the isolated image 410 into areas such that each divided area (e.g., the areas 421-424) include respective different lamps of the target traffic light.

As shown in the example of FIG. 4A, the electronic device may identify a lamp turned on in the target traffic light based on average intensities calculated for each of the respective divided areas (e.g., the areas 421-424). An average intensity of an area may be an average of pixel values in the area; other area-characterizations may be used.

According to an example, the electronic device may calculate intensity values of all pixels in a divided area (e.g., the area 421) divide the sum of the calculated intensity values by the number of total pixels in the divided area (e.g., the area 421). For example, in FIG. 4A, the average intensity of the area 421 may be calculated as X₁, the average intensity of the area 422 may be calculated as X₂, the average intensity of the area 423 may be calculated as X₃, and the average intensity of the area 424 may be calculated as X₄. The electronic device may determine that a is turned-on (illuminated) based on its average intensity being greater than a first threshold intensity and/or being the largest average intensity among the areas. For example, the first threshold value may be 100. For example, it may be assumed that the average intensity of the area 421 is 120, the average intensity of the area 422 is 30, the average intensity of the area 423 is 20, and the average intensity of the area 424 is 30. When the first threshold intensity value is set to 100, the electronic device may identify, as the lamp turned on in the target traffic light, only the lamp of area 421 in which the average intensity is greater than the first threshold intensity value 100. Any known method of identifying a lit lamp in an image of a traffic signal may be used.

FIG. 4B illustrates an example of another method in which the electronic device may identify a lamp turned on in the target traffic light using an isolated image thereof. The electronic device may dispose an area corresponding to the isolated image 410 of the target traffic light, so that the lamps in the target traffic light may be arranged horizontally (e.g., on the x-axis). The electronic device may calculate an average intensity for one vertical line (e.g., the y-axis) included in the area corresponding to the isolated image 410. The electronic device may calculate the average intensity of pixels on one vertical line (e.g., a vertical line 451) as the average intensity of the one vertical line (e.g., the vertical line 451). That is, the electronic device may calculate the average value of intensity values of pixels on one vertical line (e.g., the vertical line 451) as the average intensity of the vertical line. The electronic device may calculate an average intensity for each vertical line in an area corresponding to the isolated image 410. The electronic device may calculate a graph 450 representing a relationship between a distance of one vertical line in the area corresponding to the isolated image 410 from a leftmost vertical line and the average intensity of pixels on the one vertical line.

According to an example, when vertical lines (e.g., a vertical line 452), of which the average intensity is greater than or equal to a second threshold intensity value 440, account for a threshold ratio (e.g., 30%) or more for the total number of vertical lines in a divided area (e.g., the area 421), the electronic device may identify a lamp in the divided area (e.g., the area 421) as the illuminated/lit lamp. For example, the second threshold value may be 100 but is not limited thereto.

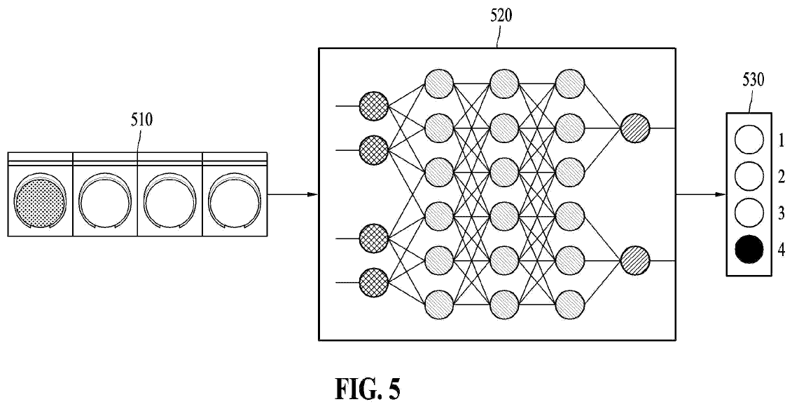

FIG. 5 illustrates an example process in which an electronic device uses a neural network to identify an illuminated lamp of a target traffic light.

The electronic device according to an example may input an isolated image 510 of the target traffic light to a neural network 520 which may predict a sequential position of a lamp that is turned on in the target traffic light. The neural network 520 may be one or more models having a machine learning structure designed to predict a relative position (position number, slot, etc.) of a turned-on lamp in the target traffic light, in response to the input of the isolated image 510.

For example, output data 530 of the neural network 520 may be information about whether a lamp corresponding to its sequential position (among the lamps) is turned on. In the example of FIG. 5, the output data 530 of the neural network 520 may indicate that a fourth lamp is turned on and the remaining lamps are not turned on.

In another example, the output data 530 of the neural network 520 may be scores corresponding to the probabilities that lamps corresponding are turned on according. For example, the output data 530 of the neural network 520 may map a k-th lamp position to a score (e.g., 5 points) corresponding to the possibility that a lamp of the k-th sequence included in the target traffic light is turned on. In this case, the electronic device may determine that the lamp corresponding to the score exceeding a threshold score (e.g., 4 points) is turned on.

The neural network 520 may be a deep neural network (DNN). The DNN may include a fully connected network (FCN), a deep convolutional network (DCN), and/or a recurrent neural network (RNN). The neural network 520 may map, based on deep learning, input data and output data that are in a non-linear relationship, to perform, for example, object classification, object recognition, speech recognition, or radar image recognition. In an example, deep learning is a machine learning scheme to solve a problem, such as object recognition, from a large data set. Through supervised or unsupervised learning, input data and output data are mapped to each other. In the case of supervised learning, the machine learning model described above may be trained based on a training input (e.g., a training image of a traffic light) and training data including a pair of training outputs mapped to the training input (e.g., a sequence according to the relative position of a lamp turned on in a training traffic light image). For example, the neural network 520 may be trained to output a training output from a training input. The neural network in training (hereinafter, referred to as a ‘temporary model’) may generate a temporary output in response to a training input and may be trained to minimize a loss between the temporary output and a training output (e.g., a ground truth value). During a training process, a parameter (e.g., a connection weight between nodes and layers in the neural network) of the neural network may be updated based on the loss.

For reference, in FIG. 5, the neural network 520 is described as a model having a machine learning structure designed to predict the sequence/position of a turned-on lamp in the target traffic light, in response to the input of the isolated image 510 of the target traffic light but is not limited thereto. The neural network 520 may be a model having a machine learning structure configured to predict the sequence number/position of a lamp turned on in the target traffic light, in response to the input of the isolated image 510 of the target traffic light and the first information indicating the number of traffic lights included in the target traffic light.

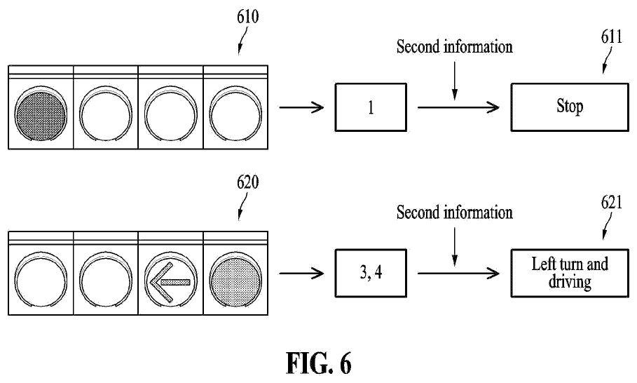

FIG. 6 illustrates an example process of an electronic device using sequence stages of lamp illuminations of a target traffic light to determine the signal state of the target traffic light.

The electronic device according to an example may load/access second information of a sequence stage according to the relative position of a lamp included in the traffic light; the relative position may be mapped to signal information (corresponding to the lamp), such information about the target traffic light having been acquired from a traffic light information acquisition module (e.g., the traffic light information acquisition module 240 of FIG. 2). The signal state of the target traffic light may be extracted from the second information about the target traffic light according to the sequence/position of a turned-on lamp in the target traffic light. In other words, information (e.g., type of traffic signal) of the turned-on lamp may be obtained according to the sequential position of the turned-on lamp; each sequential position may have its own signal information. The electronic device may determine the signal state of the target traffic light based on the thus-extracted signal information. According to an example, when two or more lamps are turned on in the target traffic light, the electronic device may determine the signal state of the target traffic light by combining pieces of the signal information mapped to the sequence according to the relative positions of the two or more lamps. In some examples, the signal information may include entries for individual lamps as well as for combinations of lamps, and the same techniques may be applied. In some examples, when multiple lamps are lit, their respective signal-states may be interpreted as both being in effect.

Referring to FIG. 6, for example, the electronic device may use an isolated image 610 of the target traffic light to determine the sequential position of a turned-on lamp to be ‘1’. In this case, the electronic device may extract signal information of ‘stop’, which is signal information mapped to the sequential position of ‘1’, from the second information about the target traffic light and may determine the state of the target traffic light to be a ‘stop’ state 611.

In another example, the electronic device may use an isolated image 620 of the target traffic light to calculate the sequences of lamps turned on in the target traffic light as ‘3’ and ‘4’. In this case, the electronic device may extract signal information of ‘left turn’ and signal information of ‘driving’, which are mapped to the sequences of ‘3’ and ‘4’, respectively, from the second information about the target traffic light and may determine the state of the target traffic light to be a ‘left turn and driving’ state 621, which is combined pieces of the signal information extracting signal states of the target traffic light.

The computing apparatuses, the vehicles, the electronic devices, the processors, the memories, the image sensors, the vehicle/operation function hardware, the automated driving systems, the displays, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of determining a signal state of a target traffic light, the method comprising:
acquiring an isolated image of the target traffic light from an input image of the target traffic light, wherein the input image is captured when the vehicle is at a position, wherein the isolated image is acquired using image processing on the input image, the input image having been captured by a camera module of the vehicle;
acquiring information about the target traffic light based on a map position in map data, the map position corresponding to the position of the vehicle when the input image is acquired; and
determining the signal state of the target traffic light based on the isolated image of the target traffic light and based on the information about the target traffic light.

2. The method of claim 1, wherein the acquiring of the isolated image of the target traffic light comprises:
identifying candidate traffic lights based on determining that the candidate traffic lights are in front of the vehicle along a driving route of the vehicle; and
selecting, as the target traffic light, whichever of the candidate traffic lights is determined to be closest to the vehicle.

3. The method of claim 1, wherein the acquiring of the information about the target traffic light comprises:
detecting the position of the vehicle using a position sensor;
determining a vehicle-map-point corresponding to the detected position of the vehicle, wherein the vehicle-map-point is in a map comprised in the map data;
selecting, based on the vehicle-map-point, a virtual traffic light among virtual traffic lights in the map as a target virtual traffic light that corresponds to the target traffic light; and
acquiring the information about the target traffic light based on the selection of the target virtual traffic light.

4. The method of claim 1, wherein the information about the target traffic light comprises first information indicating a number of lamps of the traffic light and second information indicating signal-types of respective positions of the lamps of the target traffic light.

5. The method of claim 4, wherein the determining of the signal state of the target traffic light comprises determining the sequential position of an illuminated lamp of the target traffic light based on the isolated image of the target traffic light.

6. The method of claim 5, wherein the calculating the sequential position comprises dividing the isolated image into areas respectively corresponding to the lamps of the target traffic light and computing average intensity values of the respective areas.

7. The method of claim 6, wherein the illuminated lamp is selected as a basis for determining the signal state, and wherein the illuminated lamp is selected based on the average intensity value of its corresponding area.

8. The method of claim 5, wherein the sequential position is determined by inputting the isolated image of the target traffic light to a neural network.

9. The method of claim 5, wherein the determining of the signal state of the target traffic light comprises extracting the signal information from among a set of signal information based on the signal information corresponding to the determined sequential position.

10. An electronic device for determining a signal state of a target traffic light, the electronic device comprising:
a camera module configured to capture an image of the surroundings of a vehicle connected with the electronic device;
one or more processors;
memory storing instructions configured to cause the one or more processors to:
receive map data from a server;
acquire an isolated image of the target traffic light from an input image of the target traffic light captured by the camera module while the vehicle is at a sensed physical location;
acquire, from the map data, information about the target traffic light, using the sensed physical location of the vehicle; and
determine the signal state of the target traffic light based on the isolated image of the target traffic light and the information about the target traffic light.

11. The electronic device of claim 10, wherein the instructions are further configured to cause the one or more processors to identify candidate traffic lights from images captured by respective cameras of the camera module, wherein the candidate traffic lights are determined based on being in front of the vehicle according to a driving route of the vehicle, and select, as the target traffic light, whichever candidate traffic light is determined to be closest to the vehicle among the identified candidate traffic lights.

12. The electronic device of claim 10, wherein the instructions are further configured to cause the one or more the processors to:
determine a vehicle-map-point corresponding to the sensed physical location of the vehicle in the map data;
select a virtual traffic light related to the determined vehicle-map-point among a plurality of virtual traffic lights in the map data as a target virtual traffic that corresponds to the target traffic light; and
acquire the information about the target traffic light based on the selected target virtual traffic light.

13. The electronic device of claim 10, wherein the information about the target traffic light comprises traffic-signal types respectively associated with sequential positions of lamps of the target traffic light.

14. The electronic device of claim 13, wherein the instructions are further configured to cause the one or more processors to determine, from the isolated image of the target traffic light, a sequential position of a turned-on lamp of the target traffic light, and determine the signal state of the target traffic light to be the traffic-signal type associated with the determined sequential position of the turned-on lamp.

15. The electronic device of claim 14, wherein the instructions are further configured to cause the one or more processors to compute pixel-intensity measures of areas in the isolated image that contain respective lamps of the target traffic light.

16. The electronic device of claim 15, wherein the instructions are further configured to cause the one or more processors to determine the sequential position of the turned-on lamp based on the pixel-intensities.

17. The electronic device of claim 14, wherein the instructions are further configured to cause the one or more processors to determine the sequential position by inputting the isolated image of the target traffic light to a neural network, wherein the neural network performs an inference on the isolated image to generate the sequential position.

18. The electronic device of claim 14, wherein the determined sequential position is used to select the traffic-signal type from among the traffic-signal types associated with the target traffic lamp.

19. A method comprising:
sensing a location of a moving vehicle when a camera of the vehicle captures an image of a target traffic light;
mapping the sensed location of the vehicle to a vehicle-map-location in a map, wherein the map includes traffic light elements at respective map locations in the map, wherein each traffic light element has a respectively associated signal record, wherein each signal record indicates traffic-signal-types of respective lamp positions of the corresponding traffic light element;
determining a route of the moving vehicle in the map according to the vehicle-map-location;
selecting candidate traffic light elements from among the traffic light elements based on the route in the map, and selecting, from among the candidate traffic light elements, a target traffic light element as representative of the target traffic light;
determining, based on the image of the target traffic light, a sequential lamp position of a turned-on lamp of the target traffic light; and
determining a current traffic signal state of the target traffic light to be the traffic-signal-type in the signal record of the target traffic light element whose lamp position matches the determined sequential lamp position.

20. The method of claim 19, wherein the determined current traffic signal state is used to control an autonomous or assisted driving system that is at least partially controlling driving of the vehicle.
